(19) United States
(12) Patent Application Publication
(10) Pub. No.: US 2011/0000011 A1
(43) Pub. Date: Jan. 6, 2011

(54) IMPROVED PORTABLE RESTROOM STRUCTURE, COMPONENT PARTS AND METHOD OF

(76) Inventor: Thomas Gebka, Glen Ellyn, IL (US)

Correspondence Address: LAW OFFICES OF MARK A. HAMILL, P.C., 788 WILLIS STREET, SUITE 100, GLEN ELLYN, IL, 60137, US

(21) Appl. No.: 12/919,988

(22) PCT Filed: Feb. 27, 2009
(86) PCT No.: PCT/US09/35596

§ 371 Date: Aug. 27, 2010

Related U.S. Application Data
(60) Provisional application No. 61/032,023, filed on Feb. 27, 2008.

(51) Int. Cl. E03D 1/00; G09F 7/08

(52) U.S. Cl. 4/321; 40/611.01

(57) ABSTRACT

A small shelter having an integral mount for detachably displaying an advertising panel having predetermined dimensions is provided. The small shelter includes a plurality of vertical wall panels joined together to define an interior portion of the small shelter. At least one of the plurality of vertical wall panels has an inner surface defining at least a portion of the interior space of the shelter and an outer surface defining at least a portion of the exterior surface of the shelter. The exterior surface of the shelter includes at least two integral, co-planar, advertising panel slots, which extend along opposing vertical margins of a portion of the shelter. Each of the advertising panel slots is adapted to retain a vertical edge of the advertising panel to detachably mount the first advertising panel to the exterior surface of the shelter.

This application is a continuation-in-part of U.S. Patent Application Ser. No. 61/032,023 filed on Feb. 27, 2008. The present invention is directed to small shelters frequently utilized as portable restrooms and component parts for use in the manufacture of such shelters. More particularly, the invention is directed to a novel integral mounting structure for detachably mounting advertising materials on the exterior of such shelters as well as to improved methods of mounting and removal of such advertising materials.

### FIELD OF THE INVENTION

### Background of the Invention

There are currently a variety of structures for adapting portable restrooms to serve as a display for advertising materials. One such system is described in U.S. Pat. No. 6,763,626 issued to Wiering a. The system of the '626 patent involves the installation of a multiple, large metallic clamps using hand and power tools on a series of adjacent portable restrooms. That system is more cumbersome and involves more expense to install the temporary advertising than the present inventor believes to be desirable.

Another prior art system involves wrapping series of portable restrooms in a customized printed and manufactured Mylar sheets that contains an advertising message. This system also involves more time and expense to install than the present inventor believes to be desirable.

### SUMMARY OF THE INVENTION

In one aspect of the invention a small shelter having an integral mount for detachably displaying a first advertising panel having predetermined dimensions is provided. The small shelter includes a plurality of vertical wall panels joined together to define an interior portion of the small shelter. At least one of the plurality of vertical wall panels has an inner surface defining at least a portion of the interior space of the shelter and an outer surface defining at least a portion of the exterior surface of the shelter. The exterior surface of the shelter includes at least two integral, co-planar, advertising panel slots, which extend along opposing vertical margins of a portion of the shelter. Each of the advertising panel slots is adapted to retain a vertical edge of the advertising panel to detachably mount the first advertising panel to the exterior surface of the shelter. Preferably, the shelter further includes at least one vertically elongated corner piece having a vertically elongated, integral advertising panel notch, and wherein at least one of the advertising slots is defined by at least a portion of the vertically elongated, integral advertising panel notch and by at least a portion of the outer surface of one of the plurality of vertical wall panels. However, alternately the small shelter may also be provided with at least one integral projection extending outwardly from the exterior surface of at least one of the vertical wall panels to define at least a portion of at least one of the advertising panel slots.

In another aspect of the invention, a portable shelter having an integral mount for detachably displaying an advertising panel is provided. Preferably, a improved corner piece for constructing the portable shelter is utilized which includes a body portion having a pair of wall panel notches for receipt of a vertical wall panel forming the shelter, and at least one advertising panel notch for receipt of at least one advertising panel to assist in mounting the advertising panel to shelter. Such corner pieces are preferably utilized on at least the two back corners of such a shelter, but may be utilized on four or more corners of the structure. The corner pieces of the invention are preferably adapted for use with vertical wall panel sections which are substantially planar except along their vertical edges where snap fit structures are provided. The corner piece of the invention preferably is an elongated structure which extends vertically from the base of the shelter to roof line. The horizontal length of the advertising panel notch is preferably shallow enough that the vertical edges of the flexible and resilient advertising panel can be flexed along its vertical axis such that its vertical edges are temporarily and resiliently displaced horizontally inwardly so they can be easily dismounted from the shelter.

In accordance with one alternate embodiment of the invention, a separate corner pieces is not used to join each of the vertical wall panels. Instead, the portable shelter includes at least one more rounded corner formed by fastening together overlapping inwardly curved integral corner portions located on the vertical edges of adjacent vertical wall sections. In accordance with this alternate embodiment, the vertical wall sections joined by such a rounded corner are preferably fabricated by a blow molding or similar process to accommodate the large size and complex shape of such vertical wall sections. Also, as there are no separate corner pieces to accommodate an advertising notch to define a portion of the advertising slots, at least one integral projection extending outwardly from the exterior surface of at least one of the vertical wall panels is provided to define at least a portion of at least one of the vertically elongated advertising panel slots.

In accordance with another aspect of the invention, the preferred corner piece of the invention includes, a stem portion extending inwardly toward the shelter interior, a flange portion which extends laterally from the stem portion and outwardly toward the shelter exterior. The preferred corner further includes a body portion defining a portion of an exterior corner of the portable shelter and having a pair of wall panel notches as well as at least one advertising panel notch for receipt of the vertical edge of at least one advertising panel. The flange, stem and wall panel notches combining to define an elongated vertical wall channel for receipt of the vertical edges of a vertical wall panels of the shelter.

In accordance with another aspect of the invention, a novel portable restroom is provided which includes a toilet structure mounted in the interior portion of the shelter, a base portion attached to the plurality of vertical walls, a waste holding tank in fluid communication with the toilet structure, a door for providing access to the interior portion of the shelter, a roof attached to the plurality of vertical wall panels, and at least two integral, co-planar, advertising panel slots formed therein, which extend along opposing vertical margins of a portion of the shelter, the advertising panel slots being dimensioned to retain a vertical edge of a first advertising panel to detachably mount the first advertising panel to the exterior surface of the shelter.

In accordance with another aspect of the invention, an improved method of mounting an advertising message to a portable restroom is provided including the steps of providing a portable restroom having at least two integral, advertising panel slots and with at least two of the advertising panel slots being coplanar and spaced apart a predetermined horizontal distance; selecting a resilient advertising panel having vertical edges spaced apart by a distance slightly greater than the predetermined horizontal distance when the advertising panel is held in a substantially planar conformation and slightly less than the predetermined horizontal distance when temporarily and resiliently flexed along its vertical axis; flexing the advertising panel along its vertical axis sufficiently to cause a least one vertical edge of the advertising panel to be temporarily and resiliently displaced horizontally inwardly; and inserting the at least one vertical edge of the flexed advertising panel into at least one of the advertising panel slots.

In accordance with another aspect of the invention, a method is provided for the temporary display of advertising material by which temporary advertising materials may be quickly and easily removed from the exterior surface of a portable shelter including the steps of providing a portable building having at least two corner pieces with each of the corner pieces defining at least a portion of an integral vertical advertising panel slot and with the adjacent advertising panel slots being coplanar and spaced apart a predetermined distance; providing a resilient advertising panel having vertical edges spaced apart by a distance slightly greater than the predetermined distance when the advertising panel is held in a substantially planar conformation and slightly less than the predetermined distance when temporarily and resiliently flexed along its vertical axis; flexing the advertising panel along its vertical axis sufficiently to cause a least one vertical edge of the advertising panel to be temporarily and resiliently displaced horizontally inwardly; inserting at least one vertical edge of the flexed advertising panel into at least one of the advertising panel slots; displaying the advertising indicia on the exterior surface of the advertising panel; and removing the advertising panel by flexing the advertising panel along its vertical axis enough to cause at least one of the edges of the advertising panel to be displaced sufficiently inwardly to release it from the advertising panel slot; and once the first advertising panel edge is released from the advertising panel slot, removing the other edge of the advertising panel from the advertising panel slot.

In accordance with still another aspect of the invention, a method of quickly and easily changing an advertising message mounted on the exterior surface of a portable shelter is provided, including the steps of providing a portable building having adjacent corner pieces with each of the corner pieces defining at least a portion of an integral vertical advertising panel slot and with the adjacent advertising panel slots being coplanar and spaced apart a predetermined distance; providing a resilient first advertising panel with a first advertising message thereon and having vertical edges spaced apart by a distance slightly greater than the predetermined distance when the first advertising panel is held in a substantially planar conformation and slightly less than the predetermined distance when temporarily and resiliently flexed along its vertical axis; flexing the first advertising panel along its vertical axis sufficiently to cause a least one vertical edge of the first advertising panel to be temporarily and resiliently displaced horizontally inwardly; inserting at least one vertical edge of the flexed first advertising panel into at least one of the advertising panel slots, displaying the first advertising message on the exterior surface of the first advertising panel; removing the first advertising panel by flexing the first advertising panel along its vertical axis enough to cause at least one of the edges of the first advertising panel to be displaced sufficiently inwardly to release it from the advertising panel slot; upon released of one of the edges of the first advertising panel from the advertising panel slot, removing the other edge of the panel from the advertising panel slot; providing a second resilient advertising panel with a different advertising message than the first advertising message of the first advertising panel; the second advertising panel having vertical edges spaced apart by a distance slightly greater than the predetermined distance when the second advertising panel is held in a substantially planar conformation and slightly less than the predetermined distance when temporarily and resiliently flexed along its vertical axis; inserting the at least one vertical edge of the flexed second advertising panel into at least one of the advertising panel slots, displaying the advertising message on the exterior surface of the second advertising panel.

In accordance with yet another aspect of the invention, a flexible advertising panel is provided for detachably mounting to a small shelter having a pair of coplanar, integral advertising panel slots formed in its exterior surface with the entrance to each of the pair of slots being spaced apart a predetermined horizontal distance, each of the integral advertising panel slots having predetermined depth and horizontal length dimensions. The advertising panel includes a body portion formed from a flexible, resilient material. The body portion further including a first surface for display of an advertising message and a pair of vertical edges spaced apart a horizontal distance greater than the predetermined horizontal distance between the entrance to the pair of advertising slots, but less than the sum of (a) the predetermined horizontal distance separating the entrance to the pair of advertising slots and (b) the combined horizontal length of the pair of advertising slots. The second surface of the body portion spaced apart from the first surface a distance less than the depth of the advertising panel slot. Such flexible advertising panels may be ordered from vendors pre-printed and already dimensioned to be mounted in the integral advertising panel slots by flexing and inserting them or they may be trimmed to size in order fit into the advertising panel slots on site by an installer. Preferably, the body portion of the flexible advertising of such advertising panels are manufacturing from a material sufficiently flexible and resilient to permit the flexible advertising panel to flex along the entirety of its vertical axis a sufficient distance that its vertical edges are temporarily displaced horizontally inwardly a sufficient distance to allow insertion of at least one of the vertical edges of the flexible advertising panel into the advertising panel slots while in a flexed state and that the pair of vertical edges of the flexible advertising panel are retained within the pair of advertising panel slots when the flexible advertising panel is allowed to return to a relaxed state.

### DESCRIPTION OF THE DRAWINGS

FIG. 1 is a front perspective view of a portable restroom in accordance with one embodiment of the invention.

FIG. 2 is a view similar to FIG. 1, but shows the portable restroom of FIG. 1 with the door in its open position.

FIG. 3 is a rear perspective view of the portable restroom of FIG. 1 with schematically illustrated advertising panels mounted thereto.

FIG. 4 is an exploded, perspective view of selected components of the restroom of FIG. 1.

FIG. 5 is an enlarged, cross-sectional view taken along lines 5-5 of FIG. 3 illustrating the arrangement of the corner pieces, wall panels and advertising panels as well as the interconnection between the vertical edges of two panels and the corner piece.

FIG. 6 is an enlarged, cross-sectional view taken along lines 5-5 of FIG. 3 showing the arrangement of the corner pieces, wall panels and illustrating the mounting of a portion of the resilient advertising panels by flexing along its vertical axis to insert one of its vertical edges into the advertising panel slots.

FIG. 7 is a rear perspective view showing the portable restroom in accordance with an alternate embodiment of the invention with schematically illustrated advertising panels mounted thereto.

FIG. 8 is an enlarged, cross-sectional view taken along lines 8-8 of FIG. 7 showing the arrangement of the roof and side wall panels.

FIG. 9 is an enlarged, cross-sectional view taken along lines 9-9 of FIG. 7 showing the arrangement of the base rails and side wall panels.

FIG. 10 is an enlarged fragmentary perspective view of the corner piece in accordance with FIG. 5.

FIG. 11 is an enlarged fragmentary cross-sectional view of a rounded corner portion and advertising slot arrangement in accordance with still another embodiment of the invention.

### DETAILED DESCRIPTION

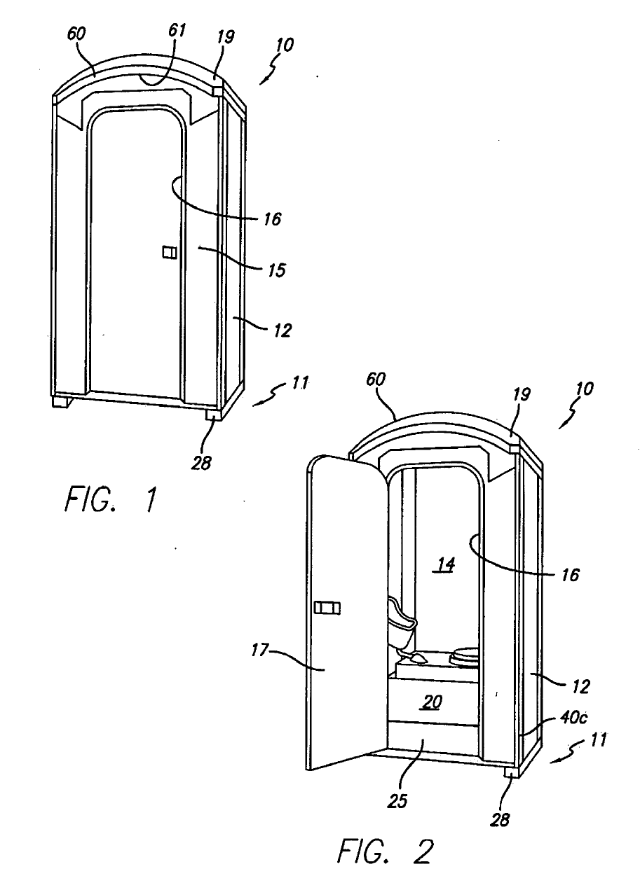

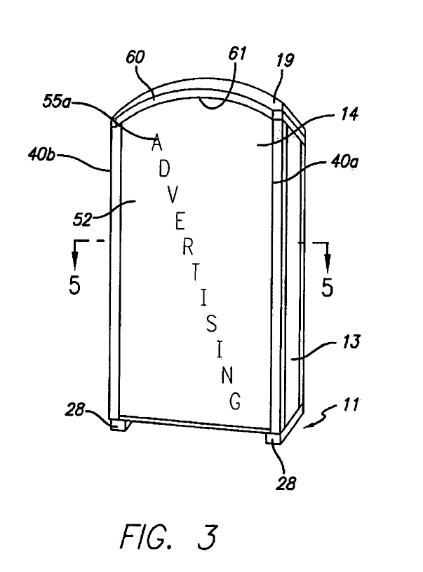

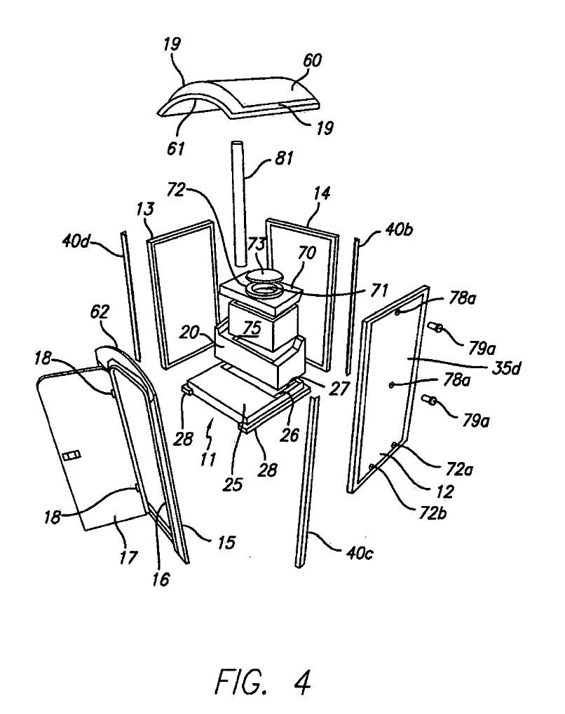

Referring to FIGS. 1-3, a portable restroom 10 is illustrated which is formed of a number of separate structural components. The restroom structure has a base 11, formed as a support pallet to which vertical wall panels 12-15 are connected. The wall panels include two side wall panels 12-13, a rear wall panel 14 and a front wall panel 15. The side and rear wall panels are substantially identical in construction in order to simplify the manufacture of the product, although they may be designed to be somewhat different if so desired. The front wall panel 15 has a doorway opening 16 which is covered by a hinged door 17. The door is connected by hinges 18 (FIG. 4) to the vertical side edge defining the doorway opening. A roof 19 covers the opening formed by the enclosure defined by the wall panels 12-15. A toilet waste tank 20 is positioned near the base of the enclosure.

As best seen in FIG. 4, the base 11 is provided with a floor panel 25 secured upon a frame 26. The floor panel is arranged forwardly of the toilet waste tank 20, leaving an opening 27 within which the toilet waste tank 20 is fitted. The base 11 includes a pair of skids or runners 28 fastened to the bottom of the frame 26. The skids 28 permit the structure to be moved upon the ground when desired and, also, enable a fork truck or other lift mechanism to be inserted between the skids beneath the frame 26 for lifting the structure. The frame, floor panel and skids may be integrally formed from molded plastic resin. However, these elements may be separately formed of different plastic resins or of wood materials, and held together by screws, rivets, nails or other fasteners.

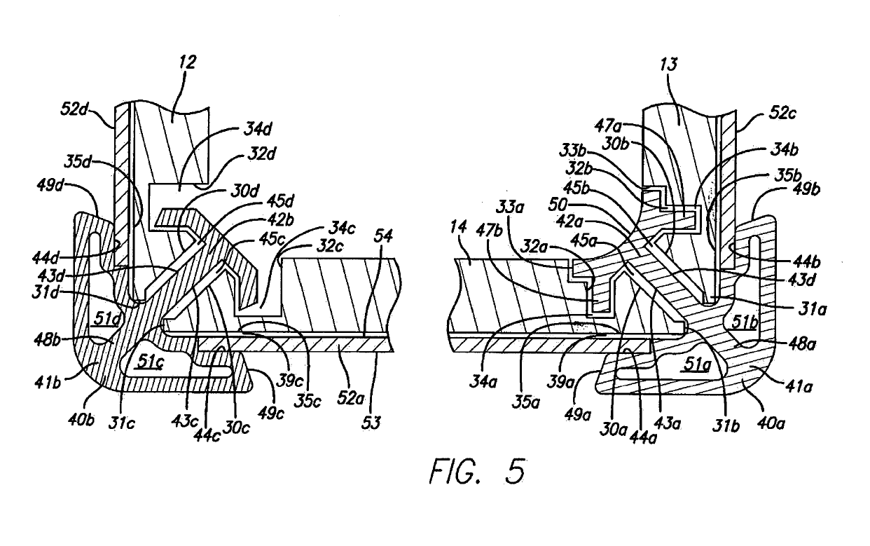

Turning in more detail to the wall panels 12-15, each of the vertical end portions of the wall panels 12-15 include snap fitting structures 29 to snap fit into complementary structures formed in the corner pieces 40 as best seen in FIG. 5. Those snap fit structures on the wall panels 12-15 include angle end portion 30, nub 31, and wall inner surface notch 32. In the embodiment of the corner piece illustrated by reference number 40a of FIG. 5, the wall panels 13 and 14 also include rounded corner piece notches 33a and 33b. The three interior surfaces of each of the wall inner surface notches 32a-d combine to define elongated vertical wall flange receiving channels 34a-d, which are dimensioned to receive flanges 47a-d, respectively. The wall panels are preferably manufactured by thermoforming, compression molding, blow molding or injection molding a resilient plastic resin or plastic composite material, but may also be formed by other similar processes. The preferred resins are those typically utilized as substitutes for structural wood products such as composites of plastic resins such as high density polyethylene (“HDPE”) or PVC with fiberglass, cellulose materials or other similar additives. Also, because of the snap fit relationship between the corner pieces 40 and the wall panels 12-15, it is preferred that the thermal expansion properties of the materials used to form those components are closely compatible. Also, it is an important consideration that the material chosen for the flange portions 47a-d of the corner pieces and the end portions of the walls panels 12-15 are both structural strong enough and sufficiently resilient to allow a snap fit between the flange 47 and angled surfaces 30 near the vertical edges of the of the vertical wall panels. Each of the wall panels 12-15 are secured to the one another by means of corner pieces 40a-d and preferably are also attached to the base 11 as best seen in the FIG. 9.

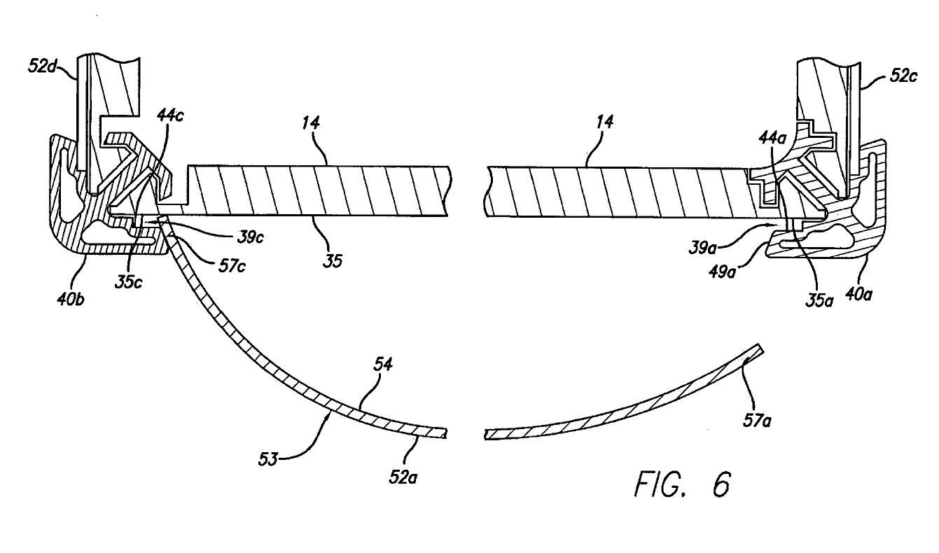

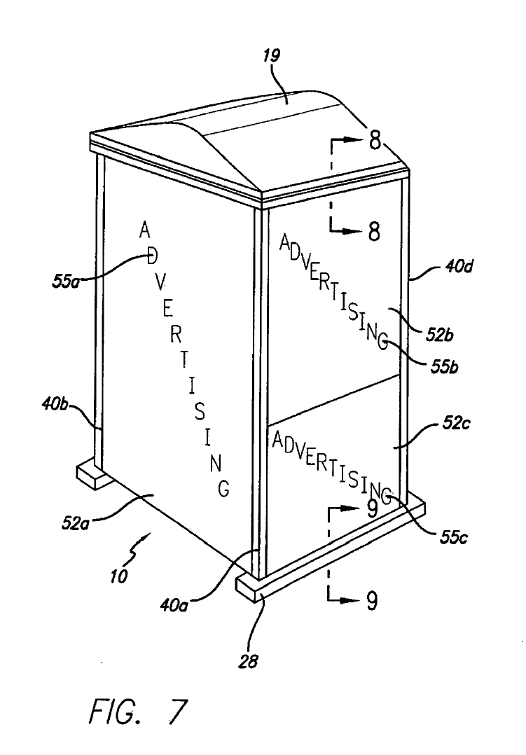

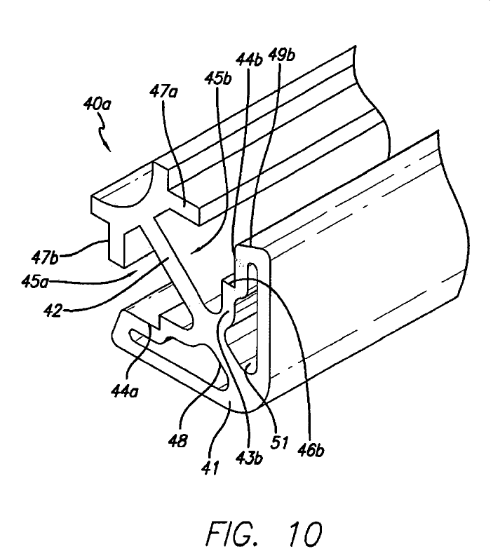

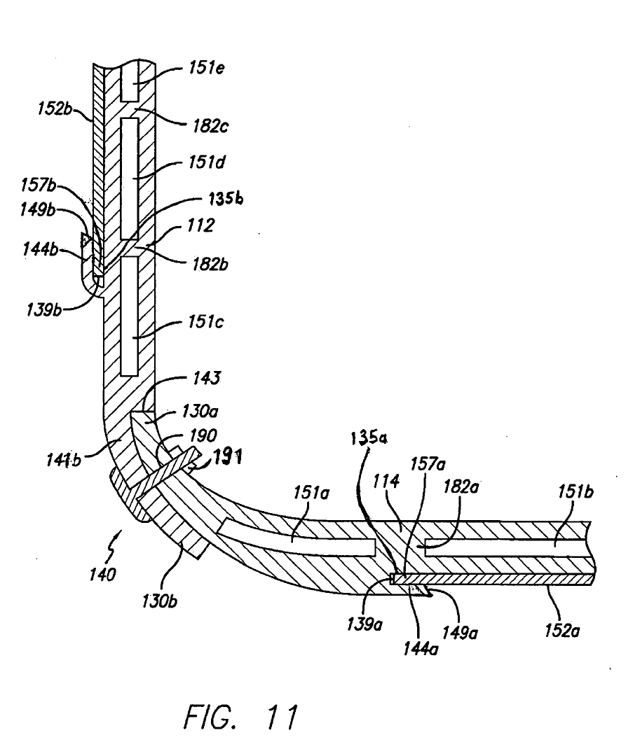

The corner piece 40, as illustrated in FIGS. 5 and 6, is shown in two different configurations 40a and 40b supporting the adjacent corners of the rear wall 14 to illustrate alternate corner piece styles for use in portable shelters in accordance with the invention. The corner piece identified by reference number 40a is believed to be the preferred configurations since the elongated convex inner corner portion is believed to provide the interior corner of the restroom 10 with an improved appearance over the more visible gaps between the corner section 40b and vertical walls 12 and 14. Each corner piece 40a, 40b includes a body portion 41a, 41b which upon assembly of the unit is located on the exterior corner of the building as best seen in FIGS. 5-6 and 10. The body portion 41 has a stem portion 42 extending inwardly toward the shelter interior. The inner surface of the body portion 42 includes wall panel notches 43a, 43b and 43c, 43d, on corner pieces 40a and 40b, respectively. The wall panel notches 43a-d cooperate with the stem portion 42a, 42b and flanges 47a-d to form a pair of elongated vertical wall panel channels 45a-d (FIGS. 5 and 10). The flanges 47a-d preferably extend both laterally outwardly from the stems 42a, 42b as well as toward the exterior of the restroom and their respective body portions 41a, 41b. Corner pieces 40a, 40b also include strap ribs 48 which serve to improve the part's strength to weight ratio and reduce resin costs. The corner pieces 40a to 40b are also provided with a camming surfaces 49a-d, which serve to urge the vertical edges 57a-d of the resilient advertising panels 52a-d into the advertising panels slots 39a-d defined by the combination of the advertising notches 44a-d and a portion of the outer surface 35a-d of the wall panels 12, 13 and 14 as best seen in FIG. 5. Preferably, the advertising panel slots 39a-d run vertically along the entire length of the corner piece 40a-d. In which case, as shown in FIG. 7, slots 39a and 39c could accommodate advertising panels with a height (vertical length) similar to that of the corner pieces 40a and 40c. However, as also shown in FIG. 7, it is contemplated that multiple advertising panels such 52c and 52d may be installed on the exterior of the wall panels 12 and 13, respectively. Alternately, if the end-user expresses a preference for installing one or more advertising panels which have a smaller vertical dimension (height) than the side wall panels 12-15 (particularly where these shorter advertising panels are not intended to be stacked one on another) the advertising panels slots may be provided with one or more pairs of advertising panel stop surfaces or tabs 78a, 78b for supporting the lower edge of the advertising panels. Also, it may be advantageous, particularly where the use of thin advertising panel is contemplated, to utilize fasteners such as threaded screws 79a, 79b for receipt in fastener apertures 80a, 80b to prevent excessive panel flexing after installation. The use of such fasteners can assist in keeping the flexible advertising panels from accidentally detaching due to flexing forces applied to the installed advertising panels caused by, for example, strong winds or movement of the portable restroom between locations.

The corner pieces 40a-d are preferably manufactured by extrusion of a tough, resilient plastic resin or plastic composite material, but may also be formed by injection molding, blow molding or similar processes. The preferred resins are those typically utilized as substitutes for structural wood products such as composites of plastic resins like high density polyethylene (“HDPE”) or PVC with fiberglass, cellulose materials or similar inert additives. It is an important consideration that the flange portions 47a-d of the corner pieces are both structural strong and sufficiently resilient to allow a snap fit between each of the flanges 47a-d and angled surfaces 30a-d near the vertical edges of the of the vertical wall panels 12-15.

In FIG. 6, the resilient advertising panel 52 is shown partially installed into the advertising slot with one vertical edge 57c partially inserted into first advertising slot 39c and the advertising panel 52a flexed along its vertical axis to allow insertion of the other vertical edge 57a into advertising slot 39a. Amount of curvature of the panel 52a during installation has been exaggerated in FIG. 6 to better illustrate the flexing properties of the advertising panel. Advertising panel 52a has an inner surface 54 and an outer surface 53. Preferably, the advertising message is printed directly onto the outer surface 53 of the advertising panel 52a. However, it may also be printed onto a sheet material and subsequently adhered to the advertising panel. Where the end user or portable restroom owner contemplates that the advertising message of a given advertising panel will be displayed on a relatively temporary basis, it is preferred than an alternate advertising message be printed or adhered to the inner surface 54 of the advertising panel such that the panel can be first mounted with the advertising message of the outer surface 53 displayed to the public. Then, after that first temporary advertising project is complete, the advertising panel 52 can be removed from the advertising slots 39 of the portable restroom 10 and reinstalled with the inner surface 54 facing outwardly to display the alternate advertising message to the public. The preferred resilient advertising panels are made from are corrugated plastic signboard, which are typically manufactured from a polypropylene material. The entrances to each of the coplanar elongated, integral advertising panel slots formed in its exterior surface of the shelter are spaced apart a predetermined horizontal distance. Each of the advertising panel slots also have a predetermined depth and horizontal length dimensions, which preferably match that of the other coplanar advertising slot. The advertising panel includes a body portion 52a formed from a flexible, resilient material. The body portion further including a first surface 53 for display of an advertising message and a pair of vertical edges 57a, 57b spaced apart a horizontal distance greater than the predetermined horizontal distance between the entrance to the pair of advertising slots 39a and 39c, but less than the sum of (a) the predetermined horizontal distance separating the entrance to the pair of advertising slots and (b) the combined horizontal length of the pair of advertising slots. The second surface 54 of the body portion spaced apart from the first surface a distance less than the depth of the advertising panel slot. Preferably, the body portion of the flexible advertising of such advertising panels are manufacturing from a material sufficiently flexible and resilient to permit the flexible advertising panel to flex along the entirety of its vertical axis a sufficient distance that its vertical edges are temporarily displaced horizontally inwardly a sufficient distance to allow insertion of at least one of the vertical edges of the flexible advertising panel into the advertising panel slots while in a flexed state and that the pair of vertical edges of the flexible advertising panel are retained within the pair of advertising panel slots when the flexible advertising panel is allowed to return to a relaxed state. Such flexible advertising panels may be ordered from vendors pre-printed and already dimensioned to be mounted into a pair of integral co-planar advertising panel slots by flexing and inserting them or the advertising panels may be trimmed to size in order fit into the advertising panel slots on site by an installer.

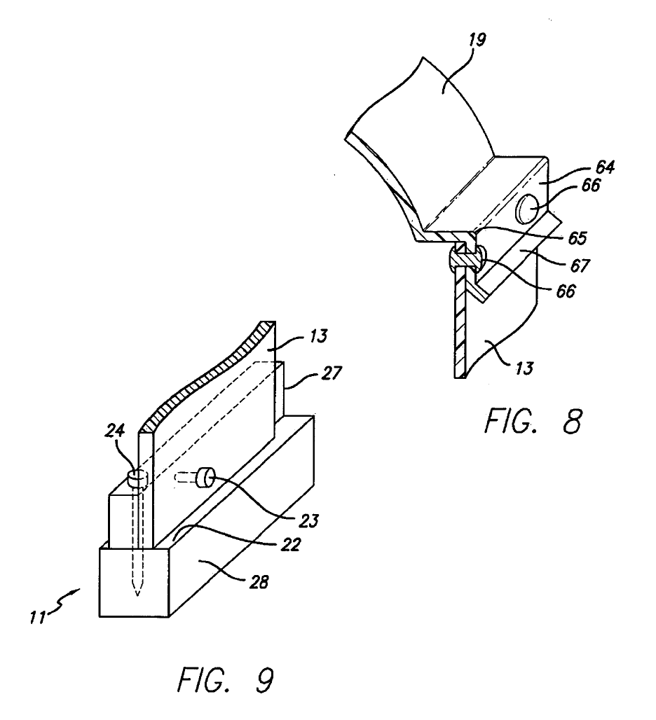

FIG. 9 illustrates the attachment of the side wall panel 13 on to skid 28 of base 11. Skid 28 includes backing member 27 which is attached by means of a fastener, preferably a nail 24. The backing member 27 provides an attachment and support surface for the side wall panel 13 for attachment to the skid 28. Side wall panel 13 is preferably connected to backing member 27 by wood screw 23. In the cross-sections views of FIGS. 8 and 9, the advertising panels 52b and 52c have been omitted so that the connections between the side walls and base 11 as well as roof 19 are more readily seen. Preferably, the skid 28 is wide enough to accommodate the thickness of the side wall panel and still leave a ledge 22 along its upper exterior surface, which can be utilized to support the lower edge of the advertising panels mounted thereon.

Returning to FIG. 4, the roof 19 has a curved or domed central portion 60 that overlies the enclosure formed by the four sidewall panels 12-15. Preferably, the forward end 61 if the roof is curved to closely fit over a similarly formed curved edge 62 on the upper edge of the front panel 15. However, it is contemplated that the front panel may alternately be provided with a relatively flat edge and another smaller panel (not shown) with a matched arcuate upper edge could be attached above to accommodate the arcuate roof line. The rear end of the cover 19 has a curved end portion 63 so that the cover fits closely over the upper, straight edge of the rear panel 14. However, where desired, the rear panel may also be formed with a curved upper edge, rather than a straight upper edge, and similarly, the roof would have a corresponding curved rear edge for closely overlapping the rear edge of the rear panel.

Referring now to FIG. 8, the roof 19 includes a continuous edge flange 64 which may has openings 65 formed therein to receive pop rivets 66 or other connectors horizontally inserted through matching openings formed in the upper edges of the respective sidewall panels. The roof is preferably made of a plastic sheet material which is somewhat resilient. For assembly, the roof may be dropped down over the tops of the sidewall panels and the openings in the edge flange 64 and along the upper edge of the sidewall panels are aligned and receive the pop rivets 66 to hold the roof 19 in place. Outwardly extending lip 67 formed on flange 64 may utilized to assist in securing the upper edge of the advertising panels since the upper edge of the advertising panel may be slid up under the flange 67 after insertion into the advertising panel slots. Where this is deemed to be unnecessary by the installer, the advertising panel may be selected or may be trimmed to be shorter than the sidewall panel 13 so that its upper edge does not reach the lip 67.

Referring once again to FIG. 4, the waste holding tank 20 is provided with a cover 70 having an upper surface in which a toilet opening 71 is formed. A conventional toilet seat 72 is arranged around the opening and may be covered by a toilet cover 73 that is connected to the waste tank cover by conventional hinges 74. Toilet waste may be dropped by gravity through the toilet opening 71 directly into the waste holding tank 20. Typically, portable restrooms waste tanks require emptying periodically. This is usually accomplished by means of a suitable large tank mounted upon a truck with a hose that is inserted into the waste holding tank. Pumping equipment on the truck pumps the contents of the waste tank into the truck tank. Then, the waste is pumped out of the truck tank into a local sewage or waste disposal system. If the end-user of the portable restroom intends to use it in this manner, the holding tank 20 is preferably fitted with an exit pipe (not shown) running along the restroom base and a sealing member (not shown) to resealably allows access to the tank for pumping out wastes.

Alternately, for end-users located in jurisdictions where the burning of human waste is permitted, a metal burn container or box 75 may be positioned within the tank 70. The container may have side handles 76 so that it may be grasped and lifted upwardly and forwardly out of the tank when desired. For that purpose, the tank cover 70 may be connected by hinges 77 to the tank. Thus, the cover may be pivoted into an open position, as shown in FIG. 4, to expose the container 76. The contents of the metal burn container may be incinerated by removing the container from the tank and carrying it a short distance away from the cabana. By applying a combustible fluid, such as gasoline or oil, the contents of the container may be burned. Preferably, the container is made of a suitable sheet metal material, such as steel sheets, while the tank may be formed of conventional plastic sheet material. The incineration of the waste material in the burn container on a periodic basis, such as daily, eliminates the necessity of waste removal equipment and, also, the need to secure a place to dump the waste.

FIG. 11 illustrates an alternate embodiment of a portable shelter in accordance with the invention, which is similar in most respects to the portable toilets shown in FIGS. 1-10. The portable shelter of FIG. 11 differs primarily in its use of integral rounded corners, instead of the separate angled corner piece components shown in the embodiments of FIGS. 1-10. In accordance with this embodiment of the invention, wall panels 112 and 114 are joined at a rounded corner 140 by fastening screw 190, which may be threaded into a nut 191, clip (not shown) or may be tapped directly into the wall panel 112 of the shelter. Each of the wall panels 112 and 114 are provided with a curved vertical edge portions 141a-b, which are adapted to overlap to form rounded corner 140. Wall panels 112 and 114 also include internal voids 151a-e which serves to improve their strength to weight ratio and reduce resin costs. The voids are periodically interrupted by cross brace members, 182a-c, which are strategically positioned along the voids to strengthen the wall panels in the areas requiring additional strength or structural rigidity. While the wall panels 112, 114 are shown in FIG. 11 as double walled structures with voids, it is contemplated that they could also be single walled panels. As seen in the cross-sectional view of FIG. 11, the inner surface of the wall panel 112 includes a wall panel corner notch 143 located adjacent to its vertical edge portion 141b, which is dimensioned to accommodate a thickened curved edge portion 130a of panel 114. A thinned curved edge portion 130b of panel 112 is also provided so that the combined thickness of the two curved edge portions 130a, 130b of panels 112 and 114 at their overlapping corner 140 is slightly greater than each individual panel 112, 114 along its planar portions. The notched/thin curved edge portions can be alternated (not shown) with thickened curved edged portions vertically along each of the wall panels 112, 114 so that they fit together in an alternating thick-thin curved edge interlocking arrangement along the vertical length of the corner 140.

Elongated vertical advertising projections 144a and 144b are located at the vertical margins of the planar portion of wall panels 112, 114 adjacent to the corner 140. The advertising panel projections 144a and 144b are provided with a camming surfaces 149a-b, which serve to urge the vertical edges 157a-b of the resilient advertising panels 152a-b into the advertising panels slots 139a-b defined by the combination of the advertising projections 144a-b and a portion of the outer surface 135a-b of the wall panels 112 and 114 as seen in FIG. 11. The project 144a is shown as having a relatively smooth transition to the corner portion 130a of panel 114. Projection 144b juts out more from remainder of the substantially planar portion of panel 112. Preferably, the advertising panel slots 139a-d run vertically along nearly the entire length of the corner 140. FIG. 11 show a cross-section of a single integral corner 140 with a pair of integrated advertising panel slots 139a-b to illustrate this alternate corner piece arrangement. It is contemplated that the shelters similar to those of FIGS. 1-10 could be constructed in which rounded, integral corners, advertising panel projection and advertising panel slots were substituted for at each of the four corners of the portable shelter or may be combined in a single shelter with one or more corner pieces similar to those shown in the embodiments of FIGS. 1-10.

The wall panels 112, 114 are preferably manufactured by thermoforming or blow molding a resilient plastic resin or plastic composite material, but may also be formed by other similar processes. Due to the complex shape, multiple large undercut portions, and size of the wall panels 112, 114, injection molding and other similar processes are less desirable for forming the type of wall panels identified by reference numbers 112, 114. The preferred resins are those typically utilized as substitutes for structural wood products such as composites of plastic resins such as high density polyethylene (“HDPE”) or PVC with fiberglass, cellulose materials or other similar additives.

Mounting of one or more suitable advertising panel to one or more side walls of the portable shelter allows for display of one or more advertising messages (e.g., 55a-c) on the exterior of the structure. This is accomplished by selecting a pair of co-planar, elongated advertising slots (e.g., 44a and 44c) to which the panel is to be mounted, measuring the horizontal distance between the entrances to each of the advertising slots formed integrally therein. Then, a resilient advertising panel having vertical edges spaced apart by a distance slightly greater than the predetermined horizontal distance when the advertising panel is held in a substantially planar conformation is either selected or can be trimmed to size from a larger panel. Next, it is preferred that one of the two vertical edges of the resilient advertising panel is slid into one of the advertising slots. The resilient advertising panel is temporarily and resiliently flexed along its vertical axis sufficient to cause the free vertical edge of the advertising panel to be temporarily and resiliently displaced horizontally inwardly; and, sliding the free vertical edge of the advertising panel into the free advertising panel slot. The above referenced method is described as a “one edge in a time” panel mounting process; however, in some cases, it may be beneficial to simultaneously mount each of the vertical edges into adjacent advertising panel slots. In this case, it may require to installers to bend and slide the opposing edges of a panel into adjacent advertising slots at the same time. Of course, as the system of the invention provides for a greatly simplified method for mounting advertising material on a portable restroom, it similarly provides for equally simplified removal method. This is particularly advantageous when the circumstance call for mounting and display of an event specific or temporary advertising messages on a portable restroom. To remove such an advertising panel, it is flexed along its vertical axis sufficiently to cause a least one vertical edge of the advertising panel to be displaced horizontally inwardly. Once, a first advertising panel edge is released from one of the advertising panel slots, the other edge of the panel may be removed by moving the second edge horizontally away from the second advertising panel slot.

Further, if the portable restroom is intended to be utilized at a variety of events with different target advertising markets and where different messages are necessary, it is highly advantageous to have the ability to rapidly install and remove advertising panels with little effort (and frequently without the use of tools) from a plurality of restrooms to customize the advertising message for such different markets or events. In one method of the invention, a new advertising panel having a different advertising message can be rapidly and easily substituted by the following the steps set forth in the immediately proceeding paragraph and then flipping the panel over and mounting to display the alternate message applied to the inner surface of the same advertising panel or a different panel with an alternate advertising method may be mounted to the portable restroom When the event or advertising message and is one that is likely to be reused periodically, it is contemplated that the end-user or portable restroom owner may choose to store the uninstalled advertising panels for future use.

However, if the advertising message is likely to be utilized at a one time end, it may be preferable and environmentally more responsible to reuse the same advertising panel for a number of different events by merely apply a freshly printed advertising message sheet to a previously used advertising panel. In accordance with this method of the invention, a thin advertising indicia sheet is printed with an advertising message on its exterior surface and an adhesive material on its backing surface. When utilizing this method, it is preferred that the reused advertising panel is first removed from the advertising panel slot prior to adhering the new printed adverting sheet to the panel to be reused.

The above description is by way of example and changes may be made in the above construction and different embodiments of the invention may be made without departing from the scope of this invention, and is intended that all matter contained in the above description or shown in the accompanying drawings shall be interpreted as illustrative and not in a limiting sense. Accordingly, the invention of this patent application is to be limited only by the following claims.

What is claimed is:

1. An improved small shelter having an integral mount on the exterior of the shelter for detachably displaying a first advertising panel, comprising:
a plurality of vertical wall panels joined together to define an interior portion of the small shelter, at least one of the plurality of vertical wall panels having an inner surface defining at least a portion of the interior surface of the shelter and an outer surface defining at least a portion of the exterior surface of the shelter;
the exterior surface of the shelter having at least two integral, co-planar, elongated, advertising panel slots formed therein, which extend along opposing margins of a portion of the shelter, the advertising panel slots being adapted to retain an edge of the first advertising panel to detachably mount the first advertising panel to the exterior surface of the shelter.

2. The improved small shelter of claim 1 wherein the shelter further includes a toilet structure mounted in the interior portion of the shelter, a base portion attached to the plurality of vertical walls, a waste holding tank in fluid communication with the toilet structure, a door for providing access to the interior portion of the shelter, and a roof attached to the plurality of vertical wall panels.

3. The improved small shelter of claim 1 wherein the shelter further includes at least one vertically elongated corner piece having a vertically elongated, integral advertising panel notch, and wherein at least one of the elongated advertising slots is defined by at least a portion of the vertically elongated, integral advertising panel notch and by at least a portion of the outer surface of one of the plurality of vertical wall panels.

4. The improved small shelter of claim 1 wherein the shelter further includes at least two pairs of corner pieces, each of the pairs of corner pieces having a pair of integral, coplanar advertising notches formed therein, which define at least a portion of a pair of coplanar, elongated advertising panel slots, each of the pair of advertising panel slots being further defined by a portion of the exterior surface of one of the plurality of vertical wall panels.

5. The improved small shelter of claim 1 wherein at least one of the corner pieces includes a wall panel channel integrally formed therein which is dimensioned for receipt of at least a portion of a first vertical wall panel for joining the first vertical wall panel to a second vertical wall panel at an angled corner.

6. The improved small shelter of claim 2 further including a flexible, resilient advertising panel detachably mounted thereto and wherein the flexible, resilient panel may be flexed along its vertical axis to cause the vertical edges of the advertising panel to be temporarily and resiliently displaced horizontally inwardly and which when returned to a relaxed state returns the vertical edges to their original horizontal dimensions, and wherein at least one of the pair of advertising panel slots is dimensioned to be sufficiently large to accommodate insertion of at least one of the vertical edges of the advertising panel when the advertising panel is being flexed along its vertical axis, and wherein the at least one advertising panel slot is further dimensioned to retain at least one vertical edge of the advertising panel when the panel is in its relaxed state to assist in detachable mounting the advertising panel to the exterior of the shelter.

7. The improved small shelter of claim 6 wherein the at least one advertising panel slot is dimensioned to be sufficiently large to allow detachment of a mounted advertising panel by removal of at least one of the vertical edges of the advertising panel when flexed along its vertical axis thereby causing the vertical edges of the advertising panel to be temporarily and resiliently displaced horizontally inwardly.

8. The improved shelter of claim 2 wherein at least one of the corner pieces includes a body portion defining at least a portion of the exterior corner of the small shelter body, at least a portion of each of a pair of integrally formed wall panel notches and at least a portion of an advertising panel notch, wherein the corner pieces further includes a stem portion extending from the body portion inwardly toward the interior portion of the shelter and wherein each of the corner pieces further include a flange portion extending laterally from the stem portion and having at least a portion extending outwardly toward the shelter exterior and which defines at least a portion of the vertical wall panel channel, the flange portion having a convex inner surface defining at least a portion of an interior corner of the shelter.

9. The improved small shelter of claim 5 wherein each of the integral wall panel channels of the at least two corner pieces is dimensioned to be slightly smaller than the dimensions of the vertical edges of the plurality of wall panels and wherein the at least two corner pieces are formed of a resilient material such that the vertical edges of the wall panels can be snap fit and retained in the integral wall panel channels of each of the at least two corner pieces.

10. The improved shelter of claim 9 wherein the vertical wall panels include angled surfaces adjacent to elongated wall panel channels and wherein the stem and flange portions of the corner pieces are formed from a sufficiently resilient material that insertion of the angled surfaces cause the flange portion of the corner piece to be displaced toward the interior of the shelter and further insertion past the apex of the angled wall portion cause the flange portion to be displaced outwardly into the wall surface notch of the vertical wall panel.

11. The improved shelter of claim 1 wherein the outer surface of the at least one vertical wall panel includes a pair of integral elongated projections extending outwardly therefrom and wherein at least a portion of each of the at least two integral, co-planar, advertising panel slots is further defined by at least a portion of one of the pair of integral vertical projection.

12. An improved corner piece for use in a portable shelter having a plurality of vertical wall panels, the corner piece comprising:
a body portion defining at least a portion of a first wall panel channel which is dimensioned for receipt of at least a portion of one of the vertical wall panels for joining one of the other vertical panels to another of the vertical panels forming an angled corner of the portable shelter, the body portion further including at least one advertising panel notch formed therein which is dimensioned for receipt of a vertical edge of an advertising panel between the corner piece and at least the portion of one of the vertical wall panels to assist in mounting the advertising panel to the surface of the shelter.

13. The improved corner piece of claim 10 wherein the body portion includes defines at least a portion of a second wall panel channel, which is angled relative to the first wall panel channel and is dimensioned for receipt of at least a portion of another of the vertical wall panels for joining one of the other vertical panels at an angle to the another of the vertical panels forming the shelter, the body portion further including a second advertising panel notch formed therein, which is angled relative to the first advertising panel notch and is dimensioned for receipt of a vertical edge of a second advertising panel between the corner piece and at least the portion of another of the vertical wall panels to assist in mounting the second advertising panel to the surface of the shelter.

14. The improved corner piece of claim 12 wherein the at least one advertising panel notch and a portion of a vertical wall panel define at least a portion of an elongated advertising panel slot therebetween for receipt of a vertical edge of an advertising panel to assist in mounting the advertising panel to the surface of the shelter.

15. The improved corner piece of claim 11 wherein the corner piece includes an outwardly projecting flange portion adapted to be inwardly displaced by contacting a portion of a vertical wall panel during insertion of the wall panel into the vertical wall panel channel and wherein the corner piece is extruded from a flexible resilient material such that it flexes inwardly when contacting an angled portion of a vertical wall panel and moves outwardly after the angled portion passes by the flange during insertion whereby the corner piece and vertical wall panel are joined together in a snap-fit relationship.

16. A flexible advertising panel for detachably mounting to a small shelter having a pair of elongated, integral advertising panel slots formed in its exterior surface with the entrance to each of the pair of slots being spaced apart a predetermined horizontal distance, each of the elongated, integral advertising panel slots having predetermined depth and horizontal length dimensions, the advertising panel comprising:
a body portion formed from a flexible, resilient material; the body portion including;
a first surface for display of an advertising message;
a pair of vertical edges spaced apart a horizontal distance greater than the predetermined horizontal distance between the entrance to the pair of advertising slots, but less than the sum of (a) the predetermined horizontal distance separating the entrance to the pair of advertising slots and (b) the combined horizontal length of the pair of advertising slots; and
a second surface spaced apart from the first surface a distance less than the depth of the advertising panel slot.

17. The flexible advertising panel of claim 16 wherein the materials for manufacturing the body portion of the advertising panel are selected to be sufficiently flexible and resilient to permit the flexible advertising panel to flex along the entirety of its vertical axis a sufficient distance that its vertical edges are temporarily displaced horizontally inwardly a sufficient distance to allow insertion of at least one of the vertical edges of the flexible advertising panel into the advertising panel slots while in a flexed state and such that the pair of vertical edges of the flexible advertising panel are retained within the pair of advertising panel slots when the flexible advertising panel is returned to a relaxed state.

18. An improved method of detachably mounting an advertising message to a portable restroom including the steps of:
providing a portable restroom having an exterior surface into which two integral, coplanar, vertically elongated advertising slots are formed, the two integral, coplanar, vertically elongated advertising slots each being adapted for detachably mounting advertising panels of the predetermined dimensions and having an entrance spaced apart a predetermined horizontal distance and each vertically elongated advertising slot having a predetermined horizontal length;
providing a resilient advertising panel having vertical edges spaced apart by a distance greater than the predetermined horizontal distance, but less than the sum of the predetermined horizontal distance and the combined horizontal lengths of the two advertising slots, when the advertising panel is maintained in a relaxed, substantially planar conformation, the resilient advertising panel having at least one surface displaying an advertising message; and;
flexing the advertising panel along its vertical axis sufficiently to cause the vertical edges of the advertising panel to be temporarily and resiliently displaced horizontally inwardly to a horizontal distance less than the predetermined horizontal distance to allow for insertion of at least one of the vertical edges of the resilient advertising panel into at least one of the integral coplanar, vertically elongated advertising slots;
inserting at least one vertical edge of the flexed advertising panel into at least one of the integral coplanar, vertically elongated advertising slots;
allowing the flexed advertising panel to return to its relaxed state such that the vertical edges of the advertising panel move horizontally outwardly to a horizontal distance greater than the predetermined horizontal distance to allow the two integral, coplanar, vertically elongated advertising slots to retain the vertical edges of the advertising panel to assist in detachably mounting the advertising panel to the exterior surface of the shelter such that the at least one surface displaying an advertising message is visible from the exterior of the portable restroom.

19. The method of claim 18 wherein the method further includes the step of the flexing the advertising panel along its vertical axis sufficiently to cause the vertical edges of the advertising panel to be temporarily and resiliently displaced horizontally inwardly to a horizontal distance less than the predetermined distance to allow for removal of at least one of the vertical edges of the resilient advertising panel from at least one of the integral coplanar, vertically elongated advertising slots.

20. The method of claim 18 wherein the method further includes the steps of:
providing a second resilient advertising panel having vertical edges spaced apart by a distance greater than the predetermined horizontal distance, but less than the sum of the horizontal predetermined distance and combined horizontal length of the two slots when the second advertising panel is maintained in a relaxed, substantially planar conformation;
flexing the second advertising panel along its vertical axis sufficiently to cause the vertical edges of the advertising panel to be temporarily and resiliently displaced horizontally inwardly to a horizontal distance less than the predetermined horizontal distance to allow for insertion of the vertical edges of the resilient advertising panel into the integral coplanar, vertically elongated advertising slots;
inserting both vertical edges of the second flexed advertising panel into the integral coplanar, vertically elongated advertising slots;
allowing the second flexed advertising panel to return to its relaxed state such that the vertical edges of the second advertising panel to move horizontally outwardly to a horizontal distance greater than the predetermined horizontal distance to allow the two slots to retain the vertical edges of the advertising panel to assist in detachably mounting the second advertising panel to the exterior surface of the shelter whereby a second advertising message is displayed on the exterior surface of the shelter.
